(19) United States
(12) Patent Application Publication
(10) Pub. No.: US 2011/0058682 A1
(43) Pub. Date: Mar. 10, 2011

(54) INFORMATION REPRODUCING APPARATUS

(76) Inventor: Koji Sakuma, Kawaga-shi (JP)

(21) Appl. No.: 12/991,272

(22) PCT Filed: May 13, 2008
(86) PCT No.: PCT/JP2008/058786

§ 371 Date: Nov. 5, 2010

(51) Int. Cl. H04B 1/00

(52) U.S. Cl. 381/86

(57) ABSTRACT

The information reproducing apparatus reproduces plural information sources by switching them in a predetermined order, based on the selecting instruction of the user. When the selected information source coincides with the reference source during the switching of the information sources to be reproduced in the order in accordance with the user's selection instruction, the switching of the information sources to be reproduced is inhibited for a constant time. Namely, the reference source is continuously reproduced for the constant time and the user's selection instruction is ignored. Thereafter, when the constant time passes, the user's selection instruction becomes valid. Since the switching of the information sources to be reproduced is temporarily stopped at the reference source, the user can select the desired information source based on the reference source.

### TECHNICAL FIELD

The present invention relates to an apparatus which reproduces information by switching a plurality of information sources.

### BACKGROUND TECHNIQUE

There is known a car audio apparatus having a source switching function by using an operation button of so-called toggle type. In the apparatus of this kind, when the user pushes a specific source switching button, the sources are switched in a predetermined order. For example, every time when the user pushes the source switching button, the audio source is switched in the order of CD, MD, FM and AM.

The Patent Reference-1 discloses a sound apparatus having an operation button of toggle type, in which the user can set the order of switching the sources in response to the pushing of the operation button.

### Patent Reference-1:

Japanese Patent Application Laid-open under No. 2001-309481

### DISCLOSURE OF INVENTION

### Problem to be Solved by the Invention

The method of the Patent Reference-1 enables the user to set the switching order of the sources to the order that the user can easily remember. However, as far as the operation button of toggle type is used, the user needs to skip the source in which the user is not interested. Therefore, the user needs to push the operation button with thinking of “skipping the source X times” in his or her mind. Otherwise, the user must confirm the current source by listening to the source being reproduced one by one, with switching the sources. Such an operation requires the attention, and is not suitable to do during the driving.

The above is one example of the problems to be solved by the present invention. It is an object of the present invention to provide an apparatus enabling to switch to the target information source without performing the input operation unnecessarily repeatedly.

### Means for Solving the Problem

The invention of claim 1 is an information reproducing apparatus comprising: an operation unit to which selecting instructions of plural information sources is inputted; an information source selecting unit which selects one information source by switching the plural information sources in a predetermined order, in accordance with the selecting instruction inputted to the operation unit; a switching inhibiting unit which inhibits a switching of the information sources by the information source selecting unit, for a constant time, when the information source selected by the information source selecting unit coincides with a reference source; and a reproducing unit which reproduces the information source selected by the information source selecting unit.

The invention of claim 8 is a control method of an information reproducing apparatus comprising: an operation unit to which a selecting instruction of plural information sources is inputted; and an information reproducing unit which reproduces the information source, the method comprising: an information source selecting process which selects one information source by switching the plural information sources in a predetermined order, in accordance with the selecting instruction inputted to the operation unit; and are producing process which reproduces, by the information reproducing unit, the information source selected by the information source selecting process, wherein the information source selecting process inhibits a switching of the information source for a constant time, when the selected information source coincides with a reference source.

The invention of claim 9 is an information reproducing program executed by an information reproducing apparatus, the program makes the information reproducing apparatus function as: an operation unit to which a selecting instruction of plural information sources is inputted; an information source selecting means which selects one information source by switching the plural information sources in a predetermined order, in accordance with the selecting instruction inputted to the operation unit; a switching inhibiting means which inhibits a switching of the information source by the information source selecting means, for a constant time, when the information source selected by the information source selecting means coincides with a reference source; and a reproducing means which reproduces the information source selected by the information source selecting means.

### BRIEF DESCRIPTION OF THE DRAWINGS

FIG. 1 is a block diagram showing a configuration of an on-vehicle information reproducing apparatus according to an embodiment.

FIG. 2A is a diagram showing an appearance of a body operation unit.

FIG. 2B is a diagram showing an appearance of a remote-control operation unit.

FIGS. 3A and 3B show examples of information source switching according to a first embodiment.

FIG. 4 is a flowchart of an information source switching process according to the first embodiment.

FIGS. 5A and 5B show examples of information source switching according to a second embodiment.

FIG. 6 is a flowchart of an information source switching process according to the second embodiment.

FIGS. 7A and 7B show examples of information source switching according to a third embodiment.

FIG. 8 is a flowchart of an information source switching process according to the third embodiment.

### DESCRIPTION OF REFERENCE NUMBERS

1 Source selecting unit
5 Remote-control unit
7 Control unit
40 Remote-control operation unit
43 Source key

### MOST PREFERRED FORM TO EXERCISE THE INVENTION

According to one preferred aspect of the present invention, there is provided an information reproducing apparatus comprising: an operation unit to which selecting instructions of plural information sources is inputted; an information source selecting unit which selects one information source by switching the plural information sources in a predetermined order, in accordance with the selecting instruction inputted to the operation unit; a switching inhibiting unit which inhibits a switching of the information sources by the information source selecting unit, for a constant time, when the information source selected by the information source selecting unit coincides with a reference source; and a reproducing unit which reproduces the information source selected by the information source selecting unit.

The above information reproducing apparatus reproduces plural information sources by switching them in a predetermined order, based on the selecting instruction of the user. When the selected information source coincides with the reference source during the switching of the information sources to be reproduced in the order in accordance with the user's selection instruction, the switching of the information sources to be reproduced is inhibited for a constant time. Namely, the reference source is continuously reproduced for the constant time and the user's selection instruction is ignored. Thereafter, when the constant time passes, the user's selection instruction becomes valid. Since the switching of the information sources to be reproduced is temporarily stopped at the reference source, the user can easily select the desired information source based on the reference source.

In one mode of the above information reproducing apparatus, the reference source is one information source which is determined in advance and which is not changed. In this mode, by memorizing the order of the frequently-used information sources by using the reference source as reference, the user can easily select and reproduce the desired information source.

In the above mode, when the plural information sources include a medium reproducing source which reproduces a medium, it is preferred that the information source selecting unit includes the medium reproducing source, to which the medium is not loaded, to objects of the switching. However, it is desired that the reproducing unit outputs a warning when the information source selecting unit selects the medium reproducing source to which the medium is not loaded.

In another mode of the above information reproducing apparatus, the reference source is the information source which is being selected when a power of the information reproducing apparatus is last turned off. In this mode, when the power of the information reproducing apparatus is turned on again, the reference source is reproduced. Therefore, the user can repeatedly input the selection instruction to reproduce the plural information sources for one cycle so as to memorize the order of the desired information source based on the reference source, and then select the information source.

In another mode of the above information reproducing apparatus, the reference source is the information source which is selected by the information source selecting unit continuously for more than a predetermined time. In this mode, the information source which is reproduced by the information source selecting unit for more than the predetermined time is set to the reference source, and hence the user can easily memorize the order of the desired information source based on that information source.

In another mode of the above information reproducing apparatus, the plural information sources include a medium reproducing source which reproduces a medium, and the information source selecting unit excludes the medium reproducing source, to which the medium is not loaded, from objects of the switching. In this mode, the user reproduces the plural information sources for one cycle from the reference source as the starting point, and then determines the desired information source. Therefore, it is preferred to exclude the information source which cannot be reproduced because the medium is not loaded.

In another preferred aspect of the invention, there is provided a control method of an information reproducing apparatus comprising: an operation unit to which a selecting instruction of plural information sources is inputted; and an information reproducing unit which reproduces the information source, the method comprising: an information source selecting process which selects one information source by switching the plural information sources in a predetermined order, in accordance with the selecting instruction inputted to the operation unit; and a reproducing process which reproduces, by the information reproducing unit, the information source selected by the information source selecting process, wherein the information source selecting process inhibits a switching of the information source for a constant time, when the selected information source coincides with a reference source.

In the above control method, plural information sources are reproduced by switching them in a predetermined order, based on the selecting instruction of the user. When the selected information source coincides with the reference source during the switching of the information sources to be reproduced in the order in accordance with the user's selection instruction, the switching of the information sources to be reproduced is inhibited for a constant time. Namely, the reference source is continuously reproduced for the constant time and the user's selection instruction is ignored. Thereafter, when the constant time passes, the user's selection instruction becomes valid. Since the switching of the information sources to be reproduced is temporarily stopped at the reference source, the user can easily select the desired information source based on the reference source.

According to still another preferred aspect of the invention, there is provided an information reproducing program executed by an information reproducing apparatus, the program makes the information reproducing apparatus function as: an operation unit to which a selecting instruction of plural information sources is inputted; an information source selecting means which selects one information source by switching the plural information sources in a predetermined order, in accordance with the selecting instruction inputted to the operation unit; a switching inhibiting means which inhibits a switching of the information source by the information source selecting means, for a constant time, when the information source selected by the information source selecting means coincides with a reference source; and a reproducing means which reproduces the information source selected by the information source selecting means.

When the information reproducing apparatus executes the above information reproducing program, plural information sources are reproduced by switching them in a predetermined order, based on the selecting instruction of the user. When the selected information source coincides with the reference source during the switching of the information sources to be reproduced in the order in accordance with the user's selection instruction, the switching of the information sources to be reproduced is inhibited for a constant time. Namely, the reference source is continuously reproduced for the constant time and the user's selection instruction is ignored. Thereafter, when the constant time passes, the user's selection instruction becomes valid. Since the switching of the information sources to be reproduced is temporarily stopped at the reference source, the user can easily select the desired information source based on the reference source. The above information reproducing program can be handled in a manner stored in a storage medium.

### EMBODIMENT

Preferred embodiments of the present invention will be described below with reference to the attached drawings.

### 1st Embodiment

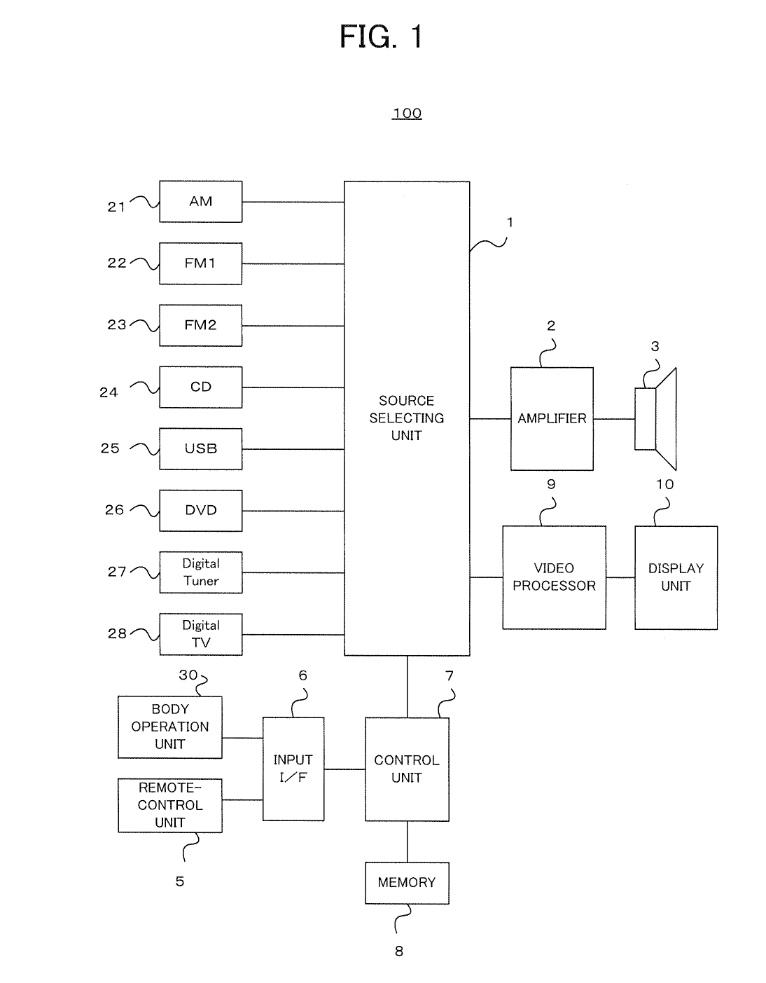

FIG. 1 is a block diagram showing a configuration of an on-vehicle information reproducing apparatus to which the present invention is applied. The on-vehicle information reproducing apparatus (hereinafter simply referred to as “information reproducing apparatus) 100 reproduces information of plural information sources. In this embodiment, as the plural information sources, there are provided an AM reproducing unit 21 for reproducing AM radio broadcasting, an FM reproducing unit 22 and 23 for reproducing FM radio broadcasting, a CD reproducing unit 24 for reproducing CD, a USB reproducing unit 25 for reproducing music information stored in a USB memory, a DVD reproducing unit 26 for reproducing DVD, a digital tuner reproducing unit 27 for reproducing digital radio broadcasting and a digital TV reproducing unit 28 for reproducing digital TV broadcasting.

The output of each of the reproducing units 21 to 28 is inputted to a source selecting unit 1. The source selecting unit 1 selects one information source out of the reproducing units 21 to 28, and outputs the audio signal of the information being reproduced to an amplifier 2. The amplifier 2 amplifies the inputted audio signal to supply it to a speaker 3, and the speaker 3 outputs the sound. Also, when the reproduction information of the selected information source includes video information, the source selecting unit 1 supplies the video information to a video processor 9 to be displayed on a display unit 10.

A control unit 7 includes a CPU, and executes the information source switching process described later by executing a program prepared in advance. A memory 8 stores the switching order of the information sources and the reference source described later, in addition to the above-mentioned program.

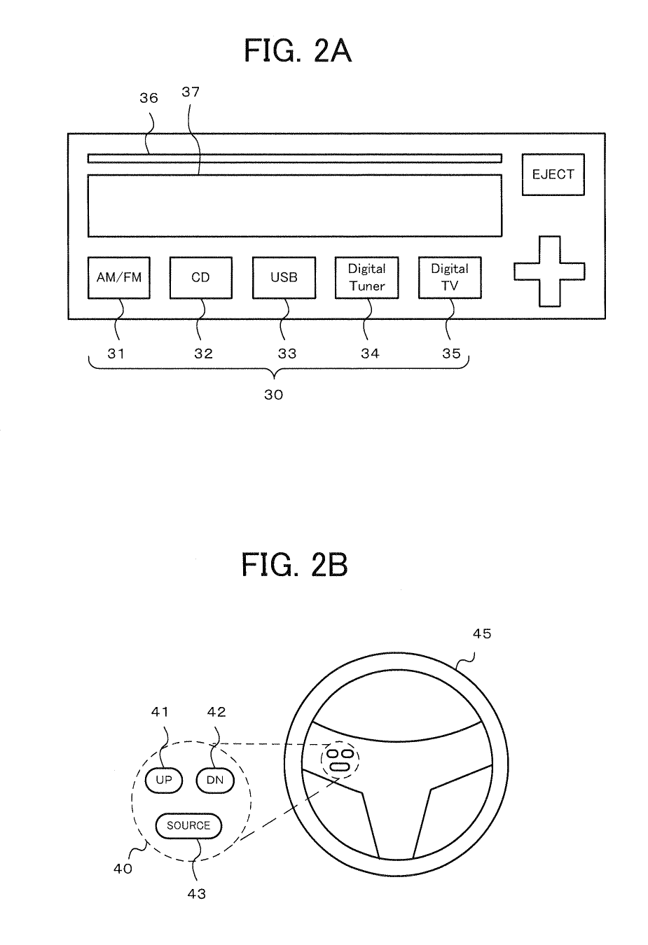

The user selects the information source to be reproduced (hereinafter referred to as “reproduction source”) from the plural information sources by operating a body operation unit 30. FIG. 2A is a front view of the body of the information reproducing apparatus 100. The body of the information reproducing apparatus 100 is provided with the body operation unit 30, a disc inserting slot 36 and a display part 37. The body operation unit 30 has plural operation buttons 31 to 35. The disc inserting slot 36 is a slot to which a disc medium to be reproduced, such as CD and DVD, is inserted. The display part 37 is a liquid crystal display, for example, and displays information relating to the information source being reproduced (track number and so on). When the user pushes one of the operation buttons 31 to 35, the selection signal of the information source corresponding to the operation button is supplied to the control unit 7 via the input I/F 6. The control unit 7 supplies the selection signal to the source selecting unit 1, and the source selecting unit 1 selects the corresponding information source. In this way, the user can directly select and reproduce a target information source by using the body operation unit 30.

In addition, the user can select the desired information source from the plural information sources by operating the remote-control operation unit 40. FIG. 2B shows an appearance of the remote-control operation unit 40. In this embodiment, the remote-control operation unit 40 is configured as a steering wheel remote-controller provided on the steering wheel 45 of the vehicle. The remote-control operation unit 40 has an UP key 41 for increasing the sound volume, a DOWN key 42 for decreasing the sound volume and a source key 43 for selecting the information source. The source key is of the toggle type, and information source is switched according to a predetermined order every time the user pushes the source key 43. The user can select the target information source by pushing the source key 43 of the remote-control operation unit 40 for necessary times.

The signal corresponding to the operation that the user did to the remote-control operation unit 40 is supplied to the remote-control unit 5, and is supplied to the control unit 7 via the input I/F 6. When the user pushes the source key 43, the remote-control unit 5 supplies the selection signal of the information source selected by the push to the control unit 7. The control unit 7 supplies the selection signal to the source selecting unit 1, and the source selecting unit 1 selects the corresponding information source.

Next, the information source switching process according to the first embodiment will be described. The information source switching process described below is executed when the user operates the source key 43 of the remote-control operation unit 40.

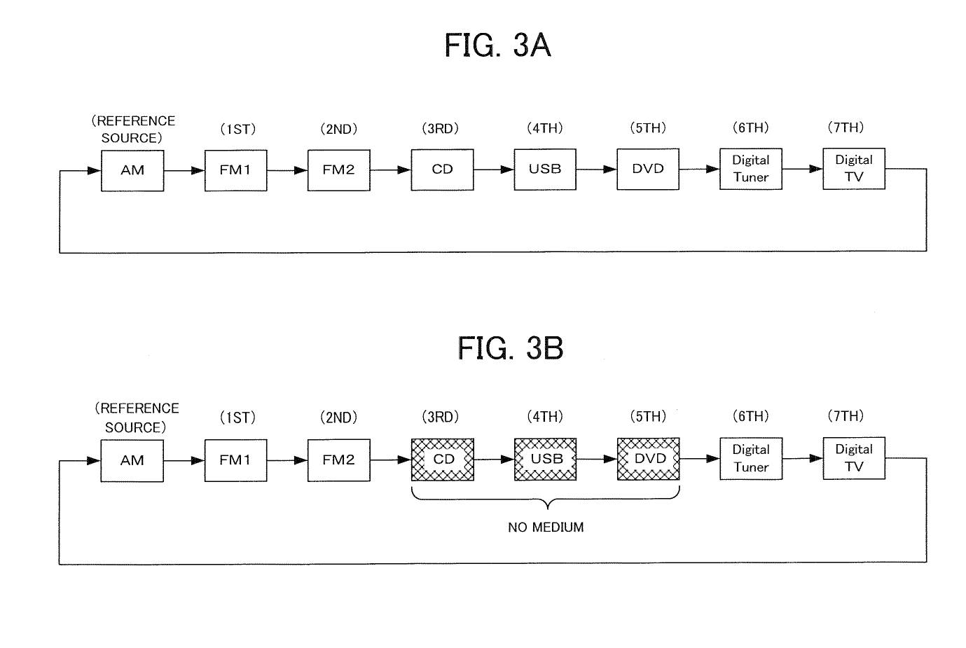

FIG. 3A shows the order by which the plural information sources are switched in accordance with the operation of the source key 43. This order is determined in advance, and is stored in the memory 8. In this embodiment, one of the plural information sources is determined as a reference source. Specifically, in the example of FIG. 3A, the information source “AM” at the top position is determined as the reference source. Therefore, based on the reference source, the next information source “FM1” is the first source, and the information source “FM2” is the second source, and the information source “Digital TV” is the seventh source.

In this embodiment, while the user is switching the reproduction source in the order shown in FIG. 3A by repeatedly pushing the source key 43, when the reproduction source coincides with the reference source, the control unit 7 inhibits the switching of the reproduction source for a constant time. For example, in FIG. 3A, when the user repeatedly pushes the source key 43 in a state that CD is selected as the reproduction source, the reproduction source is switched in the order of USB, DVD, Digital Tuner, . . . . However, when the user further pushes the source key 43 repeatedly and the reproduction source is switched to the AM which is the reference source AM, the control unit 7 ignores the user's operation to the source key 43 for the constant time thereafter. Namely, even if the user pushes the source key 43 after that, the reference source AM is continuously reproduced as the reproduction source. Then, after the passage of the constant time, the control unit 7 makes the user's operation to the source key 43 valid again, and switches the reproduction source. Namely, when the user pushes the source key 43 after the passage of the constant time, the reproduction source is switched in the order of FM1, FM2, CD, . . . .

In this way, by inhibiting the switching of the reproduction source for a constant time when the reproduction source coincides with the reference source, the user can recognize that the selection of the reproduction source returns to the reference position, i.e., the top position. Therefore, by memorizing the order from the reference source, the user can easily select the target source. In the example of FIG. 3A, as the information sources relatively frequently used, the user memorizes that the CD is at the third position from the reference source and the DVD is at the fifth position from the reference source. When the user wants to switch the information source to the CD, the user can repeatedly push the source key 43 plural times until the reference source AM is reproduced, regardless of the current reproduction source. When the user repeatedly pushes the source key 43 plural times, the reproduction source is switched to the reference source AM before long and then stops there. Namely, even if the user pushes the source key 43 further, the information source AM is reproduced for the constant time and the reproduction source is not changed. Therefore, the user can recognize that the information source reaches the reference source and then push the source key 43 three times after a while (i.e., after the passage of the constant time). By this, the CD at the third positioned from the reference source is selected as the reproduction source. Similarly, if the user wants to switch the information source to the DVD, the user can push the source key 43 five times after the passage of the constant time, when the reproduction source reaches the reference source AM.

In this embodiment, the information sources include the ones, such as CD, DVD and USB, which reproduce the information recorded on the medium (hereinafter referred to as “medium reproducing source”). In this embodiment, the medium reproducing source to which the medium is not actually loaded is the objects of the switching. For example, as shown in FIG. 3B, even if the medium is not loaded to the medium reproducing source CD, USB or DVD and hence the information cannot be actually reproduced, the control unit 7 treats each of the medium reproducing sources as the objects of the switching. This is because, in this embodiment, the user memorizes the position of the each information source by the order counted from the reference source, regardless of the presence and absence of the medium. Namely, as described above, the user memorizes the information source USB as the information source positioned at the fourth position from the reference source AM. If the medium reproducing source to which the medium is not loaded is excluded from the objects of the switching, the USB is the fourth information source from the reference source when the CD is inserted, but the USB is the third information source from the reference source when the CD is not inserted. Thus, the order counted from the reference source is changed dependently upon the presence and absence of the medium. In such a case, the user must consider the presence and absence of the medium in the medium reproducing sources when he or she selects the target information source. For this reason, in this embodiment, each of the medium reproducing sources is included in the objects of the switching even if the medium is not loaded. However, when the user selects the medium reproducing source to which the medium is not loaded, as the reproduction source, the control unit 7 issues the warning to the user notifying that the information cannot be reproduced because the medium is not loaded.

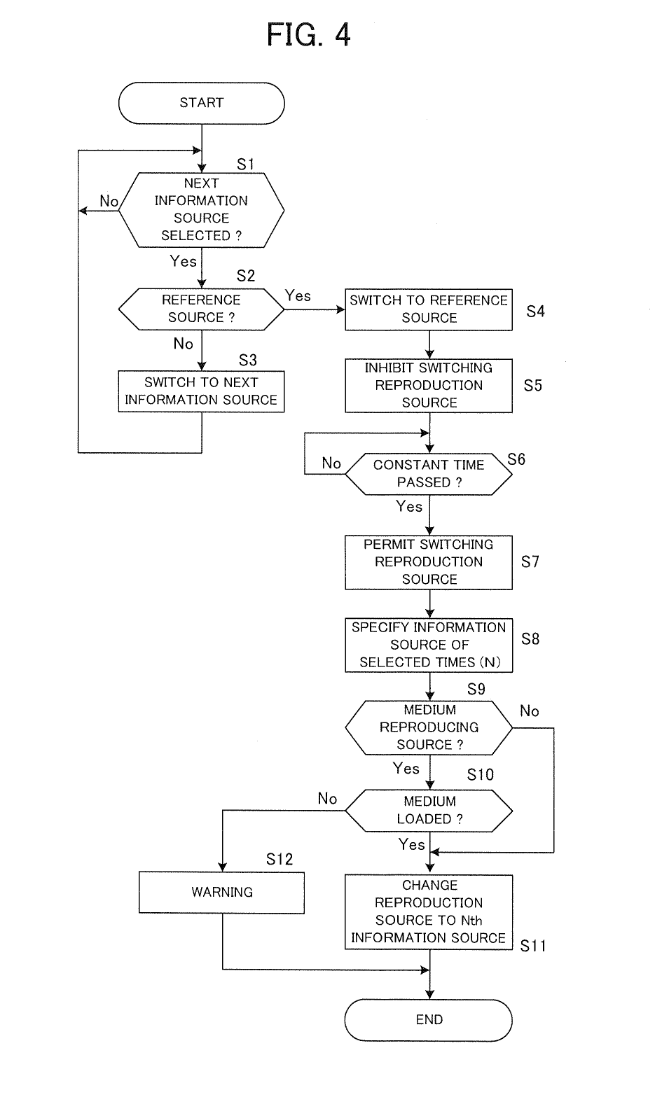

FIG. 4 shows a flowchart of an information source switching process according to this embodiment. This process is mainly realized by the control unit 7 which executes the program prepared in advance.

First, the control unit 7 determines whether or not the user operates the source key 43 and selects the next information source (step S1). When the next information source is selected (step S1; Yes), the control unit 7 determines whether or not the next information source coincides with the reference source (step S2). When the next information source is not the reference source (step S2; No), the control unit 7 switches the reproduction source to the next information source, and the process goes back to step S1.

On the other hand, when the next information source is the reference source (step S2; Yes), the control unit 7 switches the reproduction source to the reference source (step S4), and inhibits the switching of information source by the operation of the source key 43 for the constant time after that (step S5). In the above example, the switching temporarily stops at the reference source AM, and the reproduction of the AM is continued for the constant time.

Next, the control unit 7 determines whether or not the constant time has passed (step S6). When the constant time passed (step S6: Yes), the control unit 7 permits the switching of the source by the operation of the source key 43 after that (step S7). Then, the control unit 7 detects the source selecting times, i.e., the number of times (N times) that the source key 43 is operated, and specifies the information source (i.e., Nth information source) corresponding to the times of the operation by referring to the reproduction order of the information sources stored in the memory 8 (step S8).

Next, the control unit 7 determines whether or not the specified information source is the medium reproducing source (step S9). If the specified information source is not the medium reproducing source (step S9; No), the process goes to step S11. On the contrary, when the specified source is the medium reproducing source (step S9; Yes), the control unit 7 determines whether or not the medium is loaded (step S10). When the medium is loaded (step S10; Yes), the control unit 7 switches the reproduction source to that information source, i.e., the Nth information source from the reference source (step S11). Thus, the information source selected by the user is reproduced.

On the contrary, when the medium is not loaded (step S10; No), the control unit 7 issues the warning by an audio message to notify it to the user (step S12). In this case, the control unit 7 does not change the reproduction source and keeps the reproduction source to the reference source. Therefore, the user who recognizes that the medium is not loaded can select another information source again, based on the reference source.

As described above, in the first embodiment, when the user repeatedly pushes the source key 43, the switching of the information source is inhibited at the position of the reference source for the constant time. By this, the user can directly designate the target information source based on the reference source. Therefore, it can be prevented that the user continues to push the source key 43 unnecessarily repeatedly until the target information source is reproduced.

Also, it is not necessary for the user to confirm the content of the reproduction sources being switched, with pushing the source key 43. Namely, it is only necessary for the user to push the source key 43 plural times until the reference source AM is reproduced, and to push the source key 43 for the times corresponding to the target information source (e.g., three times for the CD) after waiting for a while when the AM is reproduced. The user does not have to confirm the reproduction source being switched with pushing the source key 43. Therefore, it can be prevented that the attention directed to the driving is lowered by the switching operation of the information source.

### 2nd Embodiment

Next, the second embodiment of the present invention will be described. Since the configuration of the information reproducing apparatus according to the second embodiment is the same as that of the first embodiment, the description thereof will be omitted.

Also in the second embodiment, the control unit 7 inhibits the switching of the reproduction source for the constant time at the reference source when the user repeatedly pushes the source key 43. However, in the first embodiment, the reference source is determined in advance and fixed, i.e., not changed. In contrast, in the second embodiment, when the power of the information reproducing apparatus 100 is turned off, the reference source is changed to the reproduction source at the time when the reproduction of the information reproduction apparatus 100 is ended. Namely, in the second embodiment, the reproduction source at the time when the power of the information reproducing apparatus 100 is turned off last (hereinafter referred to as “last source”) is set to the reference source.

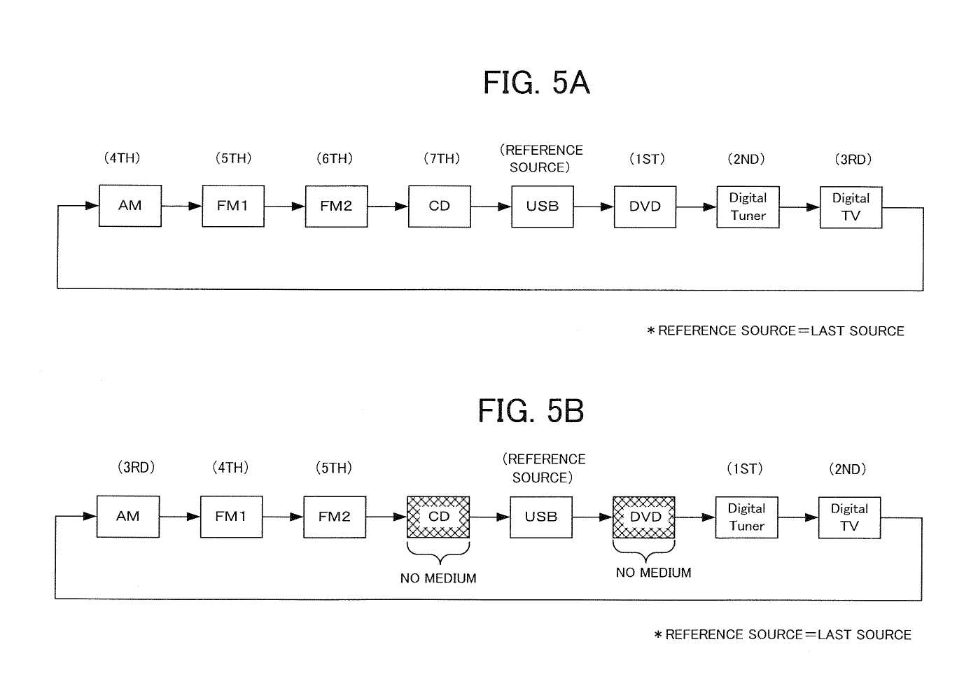

FIG. 5A shows an example of the reproduction order in the second embodiment. As shown in FIG. 5A, it is assumed that the power of the information reproducing apparatus 100 is turned off in the state that the user is reproducing the USB, and then the power of the information reproducing apparatus 100 is turned on again. In this case, the last source is the USB, and the reference source is set to the USB. When the power is turned on, the information reproducing apparatus 100 automatically starts the reproduction of the USB. Thereafter, when the user repeatedly operates the source key 43, the reproduction source is switched in the order of DVD, Digital Tuner, Digital TV, and the switching is inhibited for the constant time when the reproduction source returns to the reference source USB. By this, the user can know that the plural information sources are reproduced for one cycle from the reference source USB, which is the start point. Therefore, the user can switch the reproduction source to the target source in consideration of the order from the reference source.

For example, in the above example, when the user pushes the source key 43 no less than 8 times, the control unit 7 switches the reproduction source in the order shown in FIG. 5A, and inhibits the switching for the constant time when the reproduction source returns to the USB. While the reproduction source changes one cycle, the user determines the desired information source and memorizes the order of the information source counted from the reference source. Then, when the reproduction source changes one cycle to return to the reference source, the user can push the source key 43 for the times corresponding to the desired information source. For example, if the user determines to reproduce the digital TV, which is the 3rd information source, during the one cycle change of the reproduction source from the USB, the user can push the source key 43 three times after the reproduction source returns to the reference source USB and then the constant time passes.

In the second embodiment, every time when the power of the information reproducing apparatus 100 is turned off, the reference source is reset to the last source. For example, if the power is turned off in the state that the reproduction source is USB, the reference source is set to the USB. However, if the power is turned off in the state that the reproduction source is the DVD, the reference source is set to the DVD.

As described above, in the second embodiment, the control unit 7 switches the reproduction sources, in order, with using the last source as the reference source, until the reference source is selected next. Then, when the reproduction source returns to the reference source, the control unit 7 inhibits the switching of the reproduction source for the constant time. Therefore, during the one cycle change of the reproduction source, the user can determine the information source to be reproduced next.

Next, the treatment of the medium reproducing source in the second embodiment will be described. In the second embodiment, the control unit 7 excludes the medium reproducing source, to which the medium is not loaded, from the objects of the switching. FIG. 5B shows its example. For example, it is assumed that the CD and the DVD are not loaded, out of the medium reproducing sources CD, USB and DVD. In this case, the control unit 7 assumes that the CD and the DVD do not exist as the information source, and switches between the six information sources except for them. Therefore, as shown in FIG. 5B, when the reference source is the USB and the user pushes the source key 43 repeatedly, the reproduction source changes in the order of the Digital Tuner, the Digital TV, the AM, the FM1, the FM2 to return to the USB. This is because, in the second embodiment, the last source is the reference source, and the user determines the desired information source during the one-cycle reproduction of the all the information sources from the reference source. In other words, it is not necessary to give the information source, to which the medium is not loaded at that time and hence which cannot be reproduced, to the user as the option.

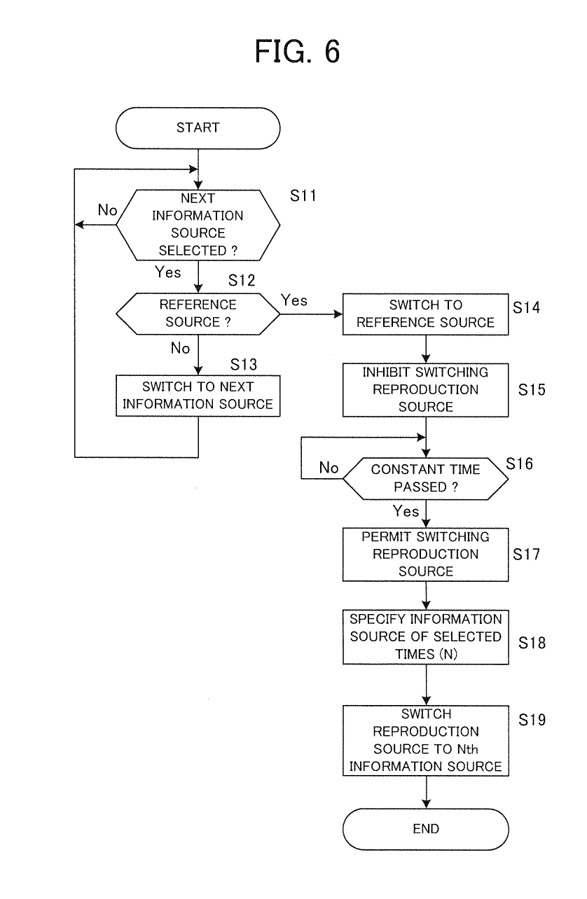

FIG. 6 is a flowchart of the information source switching process according to the second embodiment. This process is mainly executed by the control unit 7, too. At the start of the process, the control unit 7 stores the last source in the memory 8 as the reference source.

The basic flow of the process is the same as the information source switching process according to the first embodiment shown in FIG. 4. Namely, until the next information source that the user selected by the source key 43 coincides with the reference source, the control unit 7 switches the reproduction source to the next information source (steps S11 to 13). When the next information source coincides with the reference source (step S12; Yes), the control unit 7 changes the reproduction source to the reference source (step S14), and inhibits the switching of the reproduction source for the constant time (step S15, S16). When the constant time passes (step S16; Yes), the control unit 7 permits the switching of the reproduction source (step S17). Then, the control unit 7 detects the information source corresponding to the number of times (N times) that the user pushes the source key 43 (step S18), and performs the reproduction of the information source as the reproduction source (step S19).

As described above, in the second embodiment, the last source is set to the reference source, and when the user repeatedly pushes the source key 43, the switching is inhibited for the constant time after switching the reproduction source for one cycle from the reference source. Therefore, the user can easily reproduce the desired information source by memorizing the order of the desired information source counted from the reference source during the one-cycle reproduction of the reproduction sources and then pushing the source key 43 for the number of times corresponding to the order from the reference source.

### 3rd Embodiment

Next, the third embodiment will be described. Since the configuration of the information reproducing apparatus according to the third embodiment is the same as those of the first embodiment shown in FIGS. 1 and 2, the description thereof will be omitted.

Also in the third embodiment, when the user repeatedly pushes the source key 43, the control unit 7 inhibits the switching of the reproduction source at the reference source for the constant time. However, in the third embodiment, the information source which is selected by the user and reproduced more than a predetermined time is set to the reference source. While the user repeatedly pushes the source key 43 to switch the reproduction source, it is presumed that the user is looking for other information source. In contrast, when the user temporarily stops the operation of the source key 43 and the information source is reproduced more than the predetermined time, it is presumed that the user is interested in the information source and is considering deciding that information source as the reproduction source. Therefore, in the third embodiment, the control unit 7 sets the information which is reproduced more than a predetermined time to the reference source. Namely, the information source in which the user is interested is set to the reference source, and the switching of the information source is inhibited for the constant time when the user's selection by the operation of the source key 43 reaches the reference source. By this, the user can determine the desired information source before the reproduction source is changed for one cycle from the information source in which the user is interested.

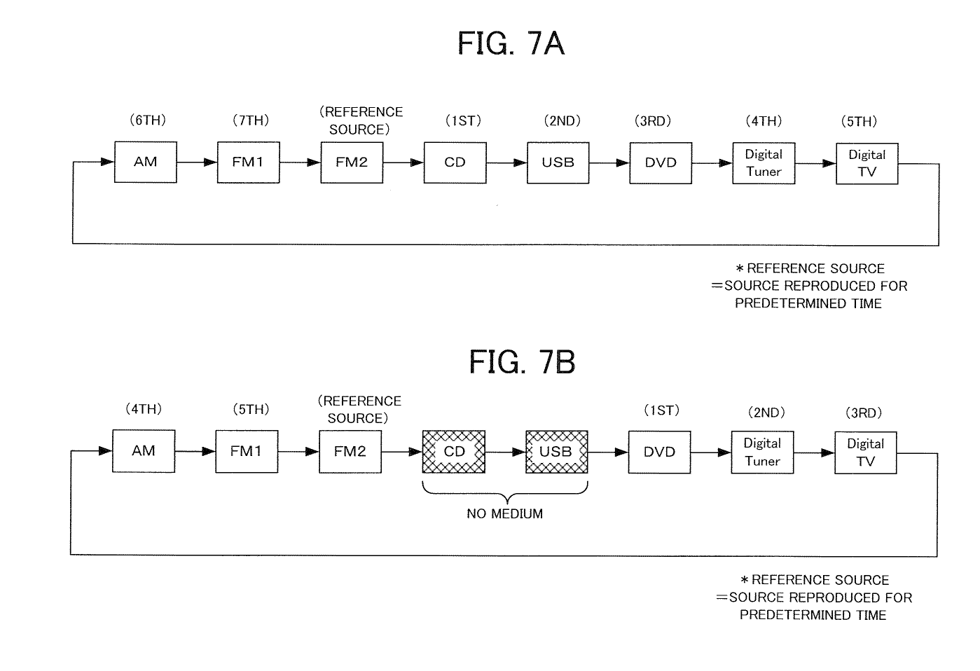

FIG. 7A shows an example of switching the reproduction source according to the third embodiment. In the case that the user is switching the information source by operating the source key 43, when the user's operation of the source key 43 stops for a while in the state that the FM2 is reproduced and the FM2 is reproduced for the predetermined time, the control unit 7 sets the FM2 to the reference source. Thereafter, the control unit 7 switches the reproduction source in order when the user repeatedly operates the source key 43. When the reproduction source reaches the FM2, which is the reference source, the control unit 7 inhibits the switching of the reproduction source for the constant time. After that, the control unit 7 switches the reproduction source in accordance with the number of times that the user operates the source key 43.

Also in the third embodiment, as shown in FIG. 7B, the medium reproducing source to which the medium is not loaded is excluded from the objects of the switching.

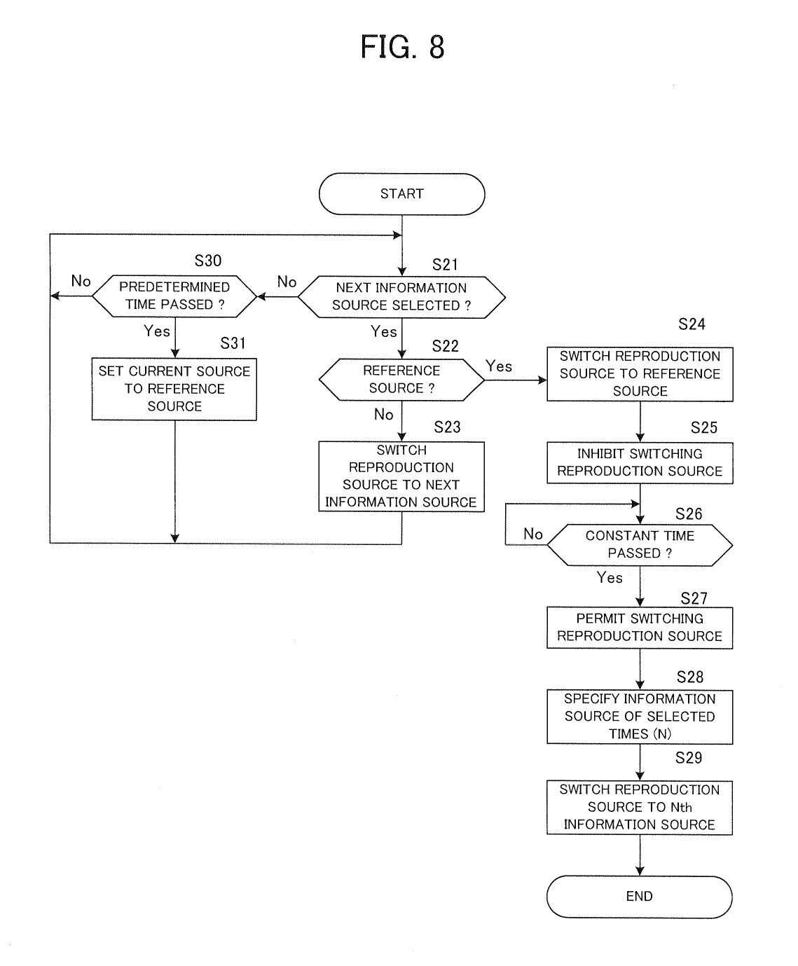

FIG. 8 is a flowchart of the information source switching process according to the third embodiment. This process is mainly executed by the control unit 7, too.

First, the control unit 7 determines whether or not the information source is selected by the user's operation of the source key 43 (step S21). When the information source is selected (step S21; Yes), the control unit 7 determines whether or not the selected information source coincides with the reference source (step S22). When the selected information source does not coincide with the reference source (step S22; No), the control unit 7 sets the selected information source to the reproduction source (step S23), and returns to step S21.

On the contrary, when the selected information source coincides with the reference source (step S22; Yes), the process goes to step S24. Steps S24 to S29 are identical to the steps S14 to S19 in the second embodiment shown in FIG. 6. The control unit 7 inhibits the switching of the reproduction source for the constant time while reproducing the reference source, and sets the information source, corresponding to the number of times that the source key 43 is operated after the constant time passes, to the reference source.

On the other hand, when the next information source is not selected (step S21; No), the control unit 7 determines whether or not the predetermined time has passed (step S30) When the predetermined time has not passed (step S30; No), the process returns to step S21. On the contrary, when the predetermined time has passed (step S30; Yes), the control unit 7 sets the current reproduction source to the reference source (step S31), and returns to step S21.

In this way, the information source which is reproduced for more than the predetermined time is set to the reference source. Therefore, the user can memorize and select the order of other information sources, by using the information source continuously reproduced for more than the predetermined time, i.e., the information source to which the user is interested and which the user remembers in some degree, as the reference source.

### Modified Example

While the present invention is applied to the on-vehicle information reproducing apparatus in the above embodiments, the application of the present invention is not limited to those. The present invention is applicable to a home-use TV, radio and AV equipment which reproduce plural information sources. For example, the service of cable TV including pay-channel has a large number of programs, and a certain program may have a rest. In such a case, if the reproduction is stopped for the constant time when the plural channels are reproduced for one cycle, the user can grasp all channels currently available. Therefore, it is possible to prevent that the user continues to switch the channels for many cycles when he or she determines the channel to watch and/or listen.

### INDUSTRIAL APPLICABILITY

This invention can be used for an information reproducing apparatus which reproduces information from plural information sources. Particularly, the present invention can be preferably applied to a home-use AV equipment as well as an on-vehicle information reproducing apparatus employing a toggle-type switch as the switching means of the information sources.

1.-10. (canceled)

11. An information reproducing apparatus comprising:
an operation unit to which selecting instructions of plural information sources is inputted;
an information source selecting unit which selects one information source by switching the plural information sources in a predetermined order, in accordance with the selecting instruction inputted to the operation unit;
a switching inhibiting unit which inhibits a switching of the information sources by the information source selecting unit, for a constant time, when the information source selected by the information source selecting unit coincides with a reference source; and
a reproducing unit which reproduces the information source selected by the information source selecting unit.

12. The information reproducing apparatus according to claim 11, wherein the reference source is one information source which is determined in advance and which is not changed.

13. The information reproducing apparatus according to claim 12, wherein the plural information sources include a medium reproducing source which reproduces a medium, and wherein the information source selecting unit includes the medium reproducing source, to which the medium is not loaded, to objects of the switching.

14. The information reproducing apparatus according to claim 13, wherein the reproducing unit outputs a warning when the information source selecting unit selects the medium reproducing source to which the medium is not loaded.

15. The information reproducing apparatus according to claim 11, wherein the reference source is the information source which is being selected when a power of the information reproducing apparatus is last turned off.

16. The information reproducing apparatus according to claim 15, wherein the plural information sources include a medium reproducing source which reproduces a medium, and wherein the information source selecting unit excludes the medium reproducing source, to which the medium is not loaded, from objects of the switching.

17. The information reproducing apparatus according to claim 11, wherein the reference source is the information source which is selected by the information source selecting unit continuously for more than a predetermined time.

18. The information reproducing apparatus according to claim 17, wherein the plural information sources include a medium reproducing source which reproduces a medium, and wherein the information source selecting unit excludes the medium reproducing source, to which the medium is not loaded, from objects of the switching.

19. A control method of an information reproducing apparatus comprising: an operation unit to which a selecting instruction of plural information sources is inputted; and an information reproducing unit which reproduces the information source, the method comprising:
an information source selecting process which selects one information source by switching the plural information sources in a predetermined order, in accordance with the selecting instruction inputted to the operation unit; and
a reproducing process which reproduces, by the information reproducing unit, the information source selected by the information source selecting process,
wherein the information source selecting process inhibits a switching of the information source for a constant time, when the selected information source coincides with a reference source.

20. A non-transitory computer-readable medium storing an information reproducing program and executed by a computer in an information reproducing apparatus, the program causing the computer to function as:
an operation unit to which a selecting instruction of plural information sources is inputted;
an information source selecting unit which selects one information source by switching the plural information sources in a predetermined order, in accordance with the selecting instruction inputted to the operation unit;
a switching inhibiting unit which inhibits a switching of the information source by the information source selecting unit, for a constant time, when the information source selected by the information source selecting unit coincides with a reference source; and
a reproducing unit which reproduces the information source selected by the information source selecting unit.
